(19) United States
(12) Patent Application Publication
(10) Pub. No.: US 2017/0234405 A1
(43) Pub. Date: Aug. 17, 2017

(54) MECHANICAL CONVERTER

(71) Applicant: Giampaolo Francesco Noia, Genoa (IT)

(72) Inventor: Giampaolo Francesco Noia, Genoa (IT)

(21) Appl. No.: 15/374,655

(22) Filed: Dec. 9, 2016

(30) Foreign Application Priority Data
Feb. 17, 2016 (JP) 2016-027866

(51) Int. Cl. F16H 1/00; F16H 1/20; F16H 31/00

(52) U.S. Cl. CPC F16H 1/003; F16H 31/001; F16H 1/20; F16F 15/30

(57) ABSTRACT

A mechanical converter of irregular bi-directional motion into continuous and consistent single direction motion through a system of gears, drive shafts, freewheels, and flywheel. The system works by transforming circular movement, both clockwise and counterclockwise from the input shaft into continuous rotation of an output shaft through the use of a pair of free wheels solidly connected to the input shaft which transfers the alternating motion, depending on the rotation of the input shaft, to two parallel secondary shafts.

### BACKGROUND OF THE INVENTION

The present invention relates to a mechanical converter, and in particular to the mechanical conversion of irregular and inconstant bidirectional circular motion to continuous and consistent single direction motion to provide an efficient source of mechanical energy needed to drive a variety of devices requiring said input.

Mechanical conversion of reciprocating motion into continuous motion is known and widely discussed in diverse applications. Numerous systems exist in the marketplace that enable the conversion of power produced by machines based on reciprocating moving parts such as pistons, plungers, floats and similar devices into continuous rotary motion about a central axis. The system most widely known is the rod-crank mechanism by virtue of its wide use in endothermic engines and others.

However, despite the presence on the market of a multiplicity of proven solutions, such systems are often very complex to manufacture and particularly expensive in terms of materials used, resulting in a less than satisfactory price-to-value ratio. Additionally, the degree of motion, frequency and duration from these sources is often inconsistent. This leads to significant inefficiencies and inadequacies in the conversion process, energy loss, and inconsistent rotational speed, which taken together result in higher operational cost.

### BRIEF SUMMARY OF THE INVENTION

The subject of the invention is a mechanical converter of irregular bi-directional circular motion into continuous and consistent single direction circular motion through a system of gears, drive shafts, freewheels, and flywheel. The system works by transforming the circular movement, both clockwise and counterclockwise from the input shaft into continuous rotation of an output shaft through the use of a pair of free wheels solidly connected to the input shaft which transfers the alternating motion, depending on the rotation of the input shaft, to two parallel transition drive shafts. These transition drive shafts are each fitted with fixed gears. A first fixed gear of the first transition drive shaft is connected to one of the freewheel gears on the input shaft. A first fixed gear of the second transition drive shaft is connected to the other of the freewheel gears on the input shaft. The first transition drive shaft interfaces with a second fixed gear on the second transition drive shaft in order to reverse the directional movement from the second shaft. A second fixed gear of the first transition drive shaft interfaces with the output shaft. The sizes of these gears and their connecting gears are determined by the number of revolutions needed to drive the intended output device, such as an energy dynamo (generator). A flywheel of sufficient mass is installed on the output shaft to ensure smooth and continuous rotation. The invention provides consistent, constant, and controlled rotational speed.

Through appropriate transmission components such as fixed and ratcheted gears, pulleys, belts, chains, toothed bars, ropes, and other technical equivalents, the input shaft of this invention can be connected to and conveniently used to transfer and transform irregular and inconsistent alternating directional motion from other mechanical sources of energy obtained from input sources such as pistons, floats. Similarly, the output shaft of the invention can be connected to a wide variety of apparatuses such as electric generators, compressors, turbines and any other device requiring a rotating axial motion at a constant speed. The conversion system described in this invention is easy to produce, sturdy, and easy to maintain, and allows for minimal loss of energy through the conversion process.

### BRIEF DESCRIPTION OF DRAWINGS

FIG. 1 shows a block diagram for an embodiment of the converter of the present invention with the identification of the main functions.

FIG. 2 shows an embodiment of the converter and identifies the structure, general components and functional connection.

### DETAILED DESCRIPTION OF THE INVENTION

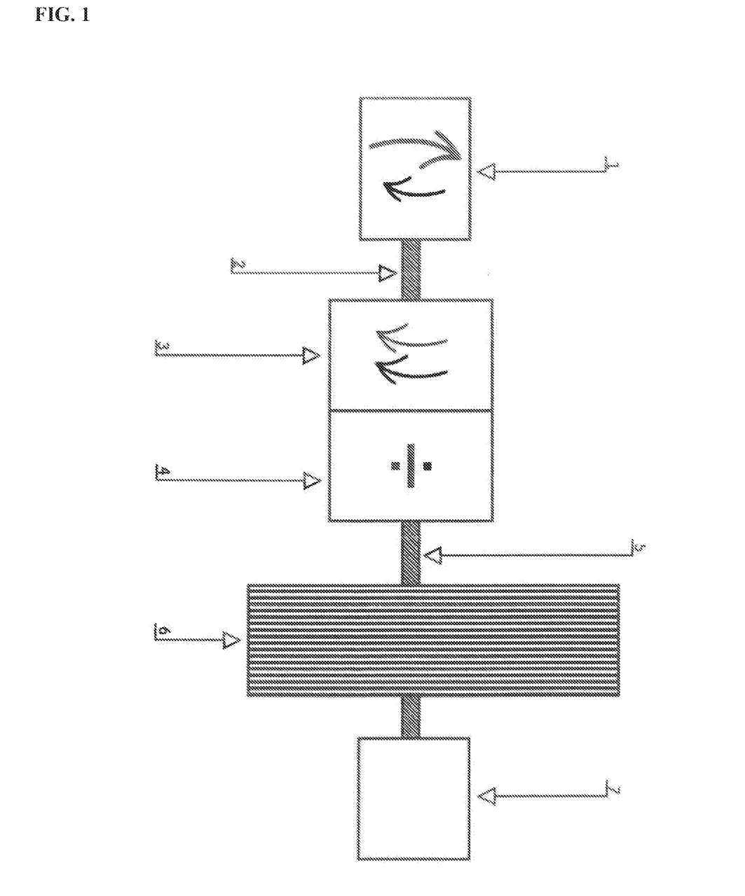

Embodiments of the invention are described below with reference to the drawings. FIG. 1, shows a schematic drawing of the components that are the are building blocks an embodiment of the invention. Block 1 represents a generic source of reciprocating, possibly asymmetric rotary motion which provides the irregular, inconsistent uncontrolled mechanical energy to Input Shaft 2. This shaft transfers the incoming clockwise and counter-clockwise motion to the Push-Pull conversion block 3 which converts the incoming clockwise and counter-clockwise motion into a unidirectional rotary motion. Revolution Multiplier 4 adjusts the number of revolutions of the Input Shaft 2 with the engine speed desired on Output Shaft 5. Flywheel 6, integrated with the Output Shaft 5 has sufficient dimensions and mass to mitigate the asymmetry of parameters such as speed and torque of the clockwise and counterclockwise motions applied to the Input Shaft 2. Generic User device 7 can be connected to Output Shaft 5 to exploit the unidirectional and continuous rotary motion.

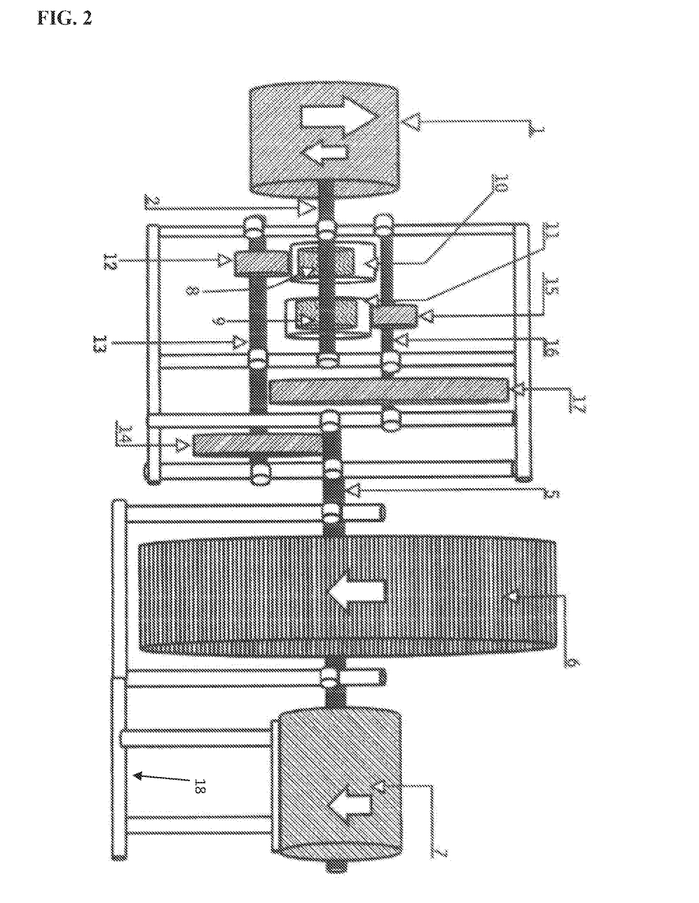

FIG. 2 shows details of the components within the schematic drawing of FIG. 1. As shown in FIG. 2, conversion of the bi-directional, irregular, inconsistent uncontrolled mechanical energy to unidirectional and continuous rotary motion is accomplished through a series of bearings, sets of shafts, fixed gears, freewheels, and various components. A detailed description of the components and their relationship to others within embodiments of the present invention is provided below.

A source of reciprocating, irregular, inconsistent uncontrolled mechanical energy 1 is integrated with the input shaft 2 that moves in the clockwise and counterclockwise by the mechanical energy source. Attached to input shaft 2 are two internal freewheel gears with pawls 8, 9 which are paired with two external and concentric gears 10, 11. The internal and external gear arrangement along with their pawls are commonly referred to as freewheel or ratchet. Their purpose is to engage and transfer power only in one direction of rotation while the other rotates freely when not engaged. The pairs 8, 10 and 9, 11 engage and transfer the power alternately depending on whether the input shaft 2 turns clockwise or counterclockwise.

When the input shaft 2 rotates in a clockwise direction, it activates the freewheel formed by the pair of internal and external freewheel gears 8 and 10 and the power is transferred to the lower transition gear 12 on lower transition shaft 13 which rotates counterclockwise with lower large-diameter transition gear 14 and transfers power to the output shaft 5, rotating it clockwise.

Similarly, if input shaft 2 rotates counter-clockwise, a pair of internal and external freewheel gears 9 and 11 transfer its power to the upper transition gear 15 which rotates clockwise together with its upper transition shaft 16 and the upper large-diameter transition gear 17. This rotation provides a counterclockwise rotation to the lower transition shaft 13 through which the lower large-diameter transition gear 14 transfers power to the output shaft 5 again causing it to rotate clockwise.

The size of the lower large-diameter transition gear 14 and the size and mass of the flywheel 6 are determined by the amount of speed and torque required by the user device 7.

During the counterclockwise and clockwise rotations of the input shaft 2, the freewheel whose rotation is inactive does not hinder operation of the system since the relative external freewheel gears 10 or 11 rotate freely in the opposite direction to the internal freewheel gears 8 or 9. Resistance or drag caused by the shaft and gears during free motion of their respective lower and upper transition shafts 13 and 16 only occur for half of the movement of the lower transition gear 12 and the upper transition gear 15.

Converter enclosure 3 is filled with machine oil and fitted with bearings for all shafts that come in contact with braces to reduce friction and wear and increase operational efficiency and lifespan. It is to be noted that the converter enclosure 3 shown in FIG. 2 can accommodate the push-pull conversion block 3 and the revolution multiplier 4 as explained referring to FIG. 1.

Frame 18 provides a sturdy structure to which flywheel 6 and the user device 7 are mounted. Bearings are provided on the frame 18 to support the output shaft 5.

In conclusion, both clockwise and counterclockwise movements applied to the input shaft 2 contribute to the output motion. As a result of the conversion process and their propensity to rotate in the same direction of output shaft 5, rotating flywheel 6 move continuously and smoothly, enabling output shaft 5 to provide single direction axial power to user device 7.

Embodiments of the present invention can be realized by technically equivalent configuration using devices or materials suitable for the purpose and scope that conform to the size of the constituent parts and can vary in a manner appropriate but consistent with the proposed solution.

The proposed solution is applicable to systems of power conversion from a source of alternating motion, where appropriate; asymmetric and variable intensity, to a continuous rotary motion and homogeneous regardless of scale factors and the range of powers involved, for example pistons and floats. An example is the wave energy conversion island platform described in my Italian patent application no. GE2014A000054 filed Jun. 9, 2014 and Japanese patent application no. 2016-027888 filed Feb. 17, 2016, for which a US application is being filed concurrently herewith.

The configuration shown in FIG. 2 is just one example of how an embodiment of the present invention can be configured. Other variations in components and configurations included within the scope of the present invention include, but are not limited to, support structure, such as supporting walls, bearings, source of input power, such as rods, shafts and gears, geometry of the components, and directions of rotation consistent with the principle of operation.

Transmission components, such as gears, belts, chains, toothed bars, ropes, and other technical equivalents that drive input shaft 2 can be used along with other components such as pistons, floats, and similar plungers with alternating motion can be converted into a continuous motion. Similarly, output shaft 5 can be linked to a variety of user equipment such as generators, compressors, turbines, and other devices requiring continuous axial rotational mechanical energy.

Modifications can be made to the embodiments described herein by those in the art without departing from the ambit of the invention. Although the invention has been described above with reference to specific embodiments, the invention is not limited to those embodiments. For example, some components shown can be combined with each other as one embodiment, and/or a component can be divided into several subcomponents, and/or any other known or available component may be added. The operation processes are also not limited to those shown in the examples. Other embodiments may be utilized and derived therefrom, such that structural and logical substitutions and changes can be made without departing from the scope of this disclosure. This Specification, therefore, is not to be taken in a limiting sense, along with the full range of equivalents to which such claims are entitled. Embodiments of the inventive subject matter can be referred to herein, individually and/or collectively, by the term “invention” merely for convenience and without intending to voluntarily limit the scope of this application to any single invention or inventive concept if more than one is in fact disclosed.

### KEY TO FIGURES

1. Reciprocation mechanical energy source
2. Input shaft
3. Push-Pull conversion block or Converter enclosure
4. Revolution multiplier
5. Output shaft
6. Flywheel
7. User device
8 and 10. Internal freewheel gear
9 and 11. External freewheel gear
12. Lower transition gear
13. Lower transition shaft
14. Lower large-diameter transition. gear
15. Upper transition gear
16. Upper transition shaft
17. Upper large-diameter transition gear
18. Frame

I claim:

1. A mechanical converter comprising:
an input shaft rotating in two directions opposite to each other;
an output shaft rotating in a single direction;
a transition mechanism mechanically coupling the input shaft with the output shaft,
wherein the transition mechanism comprises first and second freewheels disposed axially on the input shaft, first and second transition shafts each having a transition gear engaged with each freewheel, a first gear mechanism disposed between the first transition shaft and the second transition shaft, and a second gear mechanism disposed between the first transition shaft and the output shaft, a rotation of one of the two directions being transferred from the input shaft to the first transition shaft and from the first transition shaft to the output shaft whereas a rotation of the other being transferred from the input shaft to the second transition shaft, from the second transition shaft to the first transition shaft, and from the first transition shaft to the output shaft.

2. The converter of claim 1 wherein each freewheel includes an internal wheel gear and an external wheel gear engaged via a ratchet mechanism with the internal wheel gear.

3. The converter of claim 1 wherein rotational movements of the two directions are different in torque.

4. The converter of any one of claims 1 wherein the output shaft continuously rotates in the single direction.

5. The convertor of claim 3 wherein the output shaft is provided with an element for mitigating a torque difference of the rotational movements of the two directions.

6. The converter of claim 5 wherein the element includes a flywheel.

7. The converter of any one of claims I wherein a gear included in the second gear mechanism is configured to be larger than the transition gear in diameter.

8. The converter of claim 7 wherein a gear included in the first gear mechanism is configured to be larger than the gear of the second gear mechanism in diameter.

9. The converter of any one of claim 1 further comprising a revolution multiplier for adjusting revolutions of the input shaft with those required by a user device connected to the output shaft.

10. A mechanical converter for converting alternate rotational motion into continuous motion, comprising an input shaft which supports two freewheels with opposite activation directions which, through two respective transition gears transfer alternatively their rotations to two transition drive shafts according to the rotation of the input shaft, wherein the two transition drive shafts are connected with each other through a transition gear and one of the transition gear shafts is connected through an additional gear to an output shaft that always rotates in the same direction.

11. The converter of claim 10 wherein the output drive shaft is connected to a spinning flywheel used to mitigate the possible asymmetry of the clockwise and anti-clockwise torque applied to the input shaft in order to guarantee, according with the ratio of the used gears, a transfer of power to the output shaft when different torques are applied to the input shaft.

12. The converter of claim 10 wherein the additional gear is an output drive gear connected to the output shaft that facilitates the adaptation of the revolutions of the input shaft into the revolutions needed in a user device connected to the output shaft.

13. The converter of claim 10 wherein the one of the two freewheels is activated according to the rotation of the input shaft, while the other which is not activated rotates freely with the input shaft.

14. The converter of claim 11 wherein one of the two freewheels that is not activated is rotated by the spinning flywheel.
